(19) United States
(12) Patent Application Publication
(10) Pub. No.: US 2006/0279964 A1
(43) Pub. Date: Dec. 14, 2006

(54) Illuminating device, and image display apparatus incorporating same

(75) Inventor: Atsushi Kitamura, Kitasaku-gun (JP)

Correspondence Address: OLIFF & BERRIDGE, PLC, P.O. BOX 19928, ALEXANDRIA, VA, 22320, US

(73) Assignee: Minebea Co., LTD., Kitasaku-gun (JP)

(21) Appl. No.: 11/447,047

(22) Filed: Jun. 6, 2006

(30) Foreign Application Priority Data
Jun. 10, 2005 (JP) 2005-171087

(51) Int. Cl. F21V 7/04

(52) U.S. Cl. 362/620; 362/606; 362/612; 362/613

(57) ABSTRACT

An illuminating device includes: a light guide bar having a quadrangular prism configuration, formed of a transparent material, and having an optical path converting means provided on two opposite side surfaces thereof and a light source assembly composed of a plurality of point light sources and disposed at one of the two side surfaces of the light guide bar, wherein the point light sources are arrayed along the longitudinal direction of the light guide bar with their light emitting surfaces facing the one side surface of the light guide bar. Lights from the point light sources are introduced into the light guide bar from the one side surface, propagate through the light guide bar, and exit out from one end surface of the light guide bar. Also provided is an image display apparatus which includes the above-described illuminating device, a light modulating means, and a projection optical system.

### BACKGROUND OF THE INVENTION

1. Field of the Invention

The present invention relates to an image display apparatus, and more particularly to an illuminating device including a plurality of point light sources, and also to an image display apparatus incorporating such an illuminating device.

2. Description of the Related Art

Generally, a discharge lamp, such as an ultra high-pressure mercury lamp, a metal halide lamp, a xenon lamp, and the like, is used as a light source for a projection type image display apparatus, such as a consumer data projector, a video projector, and the like (hereinafter referred to as “projector” as appropriate). FIG. 10 is a schematic view of an optical system for such a projector. A projector 100 shown in FIG. 10 includes a discharge lamp 101, a reflector 102 composed of a spheroidal mirror, a light tunnel 103 having a light entrance end 103a and a light exit end 103b, a condensing optical system 104, a light modulating means 105, and a projecting optical system 106, wherein the light emission center of the discharge lamp 101 is located to coincide to one focal point of the reflector 102, and the light entrance end 103a of the light tunnel 103 is located in the vicinity of another focal point of the reflector 102. With the structure described above, light emitted from the discharge lamp 101 is reflected at the reflector 102, focused at the light entrance end 103a of the light tunnel 103 so as to be introduced into the light tunnel 103, mixed by multiple reflection while traveling through the light tunnel 103, and exits out from the light exit end 103b as a uniform light beam. The light beam goes through the condensing optical system 104, impinges on the light modulating means 105 made of, for example, a liquid crystal display element, and is modulated by the light modulating means 105 based on image data. The light modulated is projected onto a screen, and the like, thereby displaying an image.

The projector 100 described above requires a dedicated circuit to generate a high-voltage pulse for turning on the discharge lamp 101, and therefore is to be used in a conference room or a living room, where a power supply facility is provided. Recently, a simplified projector powered by battery been developed for portable use, and such a portable projector preferably incorporates a light emitting diode (LED) as a light source, which can be lighted by a simple battery-powered driving circuit, and which is high in luminous efficiency. White light is gained by using a white LED, or by multiplexing respective lights from a red (R) LED, a green (G) LED, and a blue (B) LED.

Usually, a plurality of LEDs are used to provide an image projection with a sufficient brightness and often disposed in a two-dimensional arrangement so as to form an LED array. However, for example, in the optical system shown in FIG. 10, if the aforementioned LED array is used in place of the discharge lamp 10, the following problem is caused. Since a light source structured in an LED array is virtually a surface light source to provide a two-dimensional spread, even if the LED array is set in the vicinity of the focal point of the reflector 102 with a spheroidal surface, light emitted from the LED array cannot be focused with a duly small beam diameter at the light entrance end 103a of the light tunnel 103, resulting in that leakage light failing to be introduced into the light tunnel 103 is incurred thus lowering light use efficiency.

In order to overcome the problem described above, projectors incorporating illumination optical systems as shown in FIGS. 11 to 13 have conventionally been disclosed.

Referring to FIG. 11, in a projector 200 (refer to, for example, Japanese Patent Application Laid-Open No. 2004-334082, FIG. 5 therein), an illumination optical system 201 includes a red (R) light source 262, a green (G) light source 264, and a blue (B) light source 266 (R, G and B light emitting elements) which are disposed at the respective focal points of reflectors 262b, 264b and 266b. The illumination optical system 201 further includes a dichroic filter 268 disposed equidistant from the R, G and B light sources 262, 264 and 266, a condenser lens 220 disposed ahead of the dichroic filter 268, and a light tunnel 206 disposed ahead of the condenser lens 220. In the illumination optical system 201 described above, parallel light rays emitted from the R, G and B light sources 262, 264 and 266 are reflected at or transmitted through the dichroic filter 268, and then condensed by the condenser lens 200 to be focused so as to be duly introduced into the light tunnel 206.

Referring to FIG. 12, in a projector 300 (refer to, for example, Japanese Patent Application Laid-Open No. 2004-334083, FIG. 5 therein), an illumination optical system 301 includes a red (R) light source 362, a green (G) light source 364, and a blue (B) light source 366 (R, G and B light emitting elements), condenser lenses 322, 324 and 326, optical fibers 332, 334 and 336, a condenser lens 340, and a light tunnel 306. Light rays from the R, G and B light sources 362, 364 and 366 are condensed respectively by the condenser lenses 322, 324 and 326 disposed at respective light exit areas of the R, G and B light sources 362, 364 and 366, impinge on respective light entrance ends of the optical fibers 332, 334 and 336, go through the optical fibers 332, 334 and 336, exit out from respective light exit ends of the optical fibers 332, 334 and 336, are condensed by the condenser lens 340, and impinge on the light tunnel 306.

Referring to FIG. 13, an illumination optical system 401 (refer to, for example, Japanese Patent Application Laid-Open No. 2004-110062, FIG. 1 therein) includes an LED array light source 420 and a light tunnel (referred to as light guide path block in the aforementioned Japanese Patent Application Laid-Open No. 2004-11062) 410. The LED array light source 420 is composed of a plurality of LEDs to emit R, G and B lights, which are disposed in a two-dimensional arrangement and close to the light tunnel 410 with their light emitting ends facing one end of the light tunnel 410. The cross section area of the light tunnel 410 is substantially equal to the area of the light emitting end of the LED array light source 420, so that lights emitted from the LED array light source 420 can be introduced into the light tunnel 410 without leaking outside.

In the projector 200 shown in FIG. 11, the R, G and B light sources 262, 264 and 266, the dichroic filter 268 as an optical multiplexer, and the light tunnel 206 as an optical equalizer are discretely provided, and also the condenser lens 220 is required in order to condense light rays coming from the dichroic filter 268 for introduction into the light tunnel 206. Thus, the illumination optical system 201 is forced to be large in size and high in cost.

In the projector 300 shown in FIG. 12, the R, G and B light sources 362, 364 and 366, the condenser lenses 322, 324 and 326 and the optical fibers 332, 334 and 336 as optical multiplexers, and the light tunnel 306 as an optical equalizer are discretely provided, and also the condenser lens 340 is required in order to condense light rays coming from the optical fibers 332, 334 and 336 for introduction into the light tunnel 306. Thus, the illumination optical system 301 is forced to see an increase in size and cost. In addition, since the condenser lenses 322, 324 and 326 must be provided between the light sources 362, 364 and 366 and the optical fibers 332, 334 and 336, and also since these components must be brought into a high-accuracy optical axis alignment with one another in order to achieve a good optical coupling, additional cost increase may be incurred.

In case of both the illumination optical systems 201 and 301, it is difficult to increase or decrease the number of light emitting elements without substantially modifying optical systems for optical multiplex and condensing, which are arranged around the light emitting elements, and an increase in the number of light emitting elements involves an increase in the size of the illumination optical system. Also, the aforementioned Japanese Patent Applications Laid-Open Nos. 2004-334082 and 2004-334083 disclose semiconductor laser diodes as light emitting elements for light sources, but blue and green light semiconductor laser diodes presently are low in reliability and high in cost.

In the illumination optical system 401 shown in FIG. 13, unlike the illumination optical systems 201 and 301, additional means, such as a condenser and an optical multiplexer, are not required for introducing light rays from the LED array light source 420 into the light tunnel 410, but if the number of the LEDs 421 constituting the LED array light source 420 is increased, then the cross section area of the light tunnel 410 has to be increased, which deteriorates the optical equalizing function of the light tunnel 410. The deterioration problem may be overcome by increasing the length of the light tunnel 410, but this approach results in dimensional increase of the light tunnel 410 inviting cost increase.

### SUMMARY OF THE INVENTION

The present invention has been made in light of the problems described above, and it is an object of the present invention to provide an illuminating device which is small in size and weight, and which optically multiplexes and equalizes light rays from a plurality of point light sources, and also to provide an image display apparatus incorporating the illuminating device.

In order to achieve the object described above, according to one aspect of the present invention, there is provided an illuminating device which includes: a light guide bar having a quadrangular prism configuration, formed of a transparent material, and having an optical path converting means provided on at least one of two side surfaces thereof opposite to each other; and a light source assembly composed of a plurality of point light sources and disposed at at least one of the two side surfaces of the light guide bar, wherein the plurality of point light sources are arrayed in a line along the longitudinal direction of the light guide bar such that light emitting surfaces of the point light sources face one of the two side surfaces of the light guide bar. In the illuminating device described above, lights from the point light sources are introduced into the light guide bar from the one side surface, propagate along the longitudinal direction of the light guide bar, and exit out from one end surface of the light guide bar.

Since the light guide bar serves the dual function of multiplexing and uniforming the light rays from the plurality of point light sources, the illuminating device is reduced in dimension and weight and still can emit uniform light rays with a sufficient brightness. Also, since the plurality of point light sources are arrayed in the longitudinal direction of the light guide bar along its side surface, the number of the point light sources can be readily increased by increasing the length of the light guide bar with its cross section area kept unchanged, wherein the light guide bar does not suffer deterioration of the function to multiplex and uniform light rays therefore preventing increase in the dimension and weight of the illuminating device in spite of the increase in the number of the point light sources.

In the one aspect of the present invention, the optical path converting means may preferably be constituted by a plurality of grooves formed on the side surface of the light guide bar. With this structure, light rays have their optical paths diffused by reflections at the grooves while propagating through the light guide bar, and can be effectively multiplexed. And, the design of grooves may be modified according to the parameters of the point light sources and the light guide bar to thereby optimally multiplex lights.

In the one aspect of the present invention, the plurality of point light source may include a white light emitting diode. Thus, a low-cost and high-reliability white light source can be achieved.

In the one aspect of the present invention, the plurality of point light sources may include a red light emitting diode, a green light emitting diode, and a blue light emitting diode. Since the light guide bar of the present invention functions to multiplex light rays as described above, a uniform white light can be obtained by appropriately combining respective lighting emitting diodes, and a low-cost and high-reliability white light source can be achieved.

According to another aspect of the present invention, there is provided an image display apparatus which includes: an illuminating device as described in the one aspect; a light modulating means to spatially modulate light from the illuminating device based on image information; and a projection optical system to magnify and project light from the light modulating means. In this aspect of the present invention, the light modulating means may be constituted by a liquid crystal display (LCD) element, or a digital micro device (DMD) element.

Since the illuminating device of the image display apparatus can be drastically reduced in dimension and weight, and also can be battery-driven by a simple driving circuit, the image display apparatus achieves reduction in dimension and weight thus readily providing a projection type image display apparatus suitable for mobile application. Also, since the luminous brightness of the illuminating device can be easily adjusted by changing the number of the point light sources, the image display apparatus can be flexibly designed so as to come with a suitable brightness.

### BRIEF DESCRIPTION OF THE DRAWINGS

FIG. 1A is an exploded perspective view of an illuminating device according to a first embodiment of the present invention, and FIG. 1B is an assembly view of the illuminating device of FIG. 1A;

FIG. 2 is an enlarged plan view of a portion of an optical path converting means in the illuminating device of FIG. 1A/1B;

FIG. 3A is a schematic plan view of optical paths of light rays from respective point light sources in the illuminating device of FIG. 1A/1B, and FIG. 3B is an enlarged view of a portion A of FIG. 3A;

FIG. 4 is a perspective view of an illuminating device according to a second embodiment of the present invention;

FIG. 5A is an exploded perspective view of an illuminating device according to a third embodiment of the present invention, and FIG. 5B is an assembly view of the illuminating device of FIG. 5A;

FIG. 6 is a schematic plan view of optical paths of light rays from respective point light sources in the illuminating device of FIG. 5A/5B;

FIG. 7 is a perspective view of an illuminating device according to a fourth embodiment of the present invention;

FIG. 8 is a schematic view of a relevant portion of an optical system in an image display apparatus according to a fifth embodiment of the present invention;

FIG. 9 is a schematic view of a relevant portion of an optical system in an image display apparatus according to a sixth embodiment of the present invention;

FIG. 10 is a schematic view of an optical system in a conventional projection type image display apparatus using a discharge lamp;

FIG. 11 is a schematic view of an optical system in another conventional projection type image display apparatus using a plurality of point light sources;

FIG. 12 is a schematic view of an optical system in yet another conventional projection type image display apparatus using a plurality of point light sources; and

FIG. 13 is a schematic view of an optical system in still another conventional projection type image display apparatus using a plurality of point light sources.

### DETAILED DESCRIPTION OF THE PREFERRED EMBODIMENTS

Preferred embodiments of the present invention will hereinafter be described with reference to the accompanying drawings. It is noted that the drawings are provided for explanation purpose and do not necessarily reflect the actual and correct configuration and dimension.

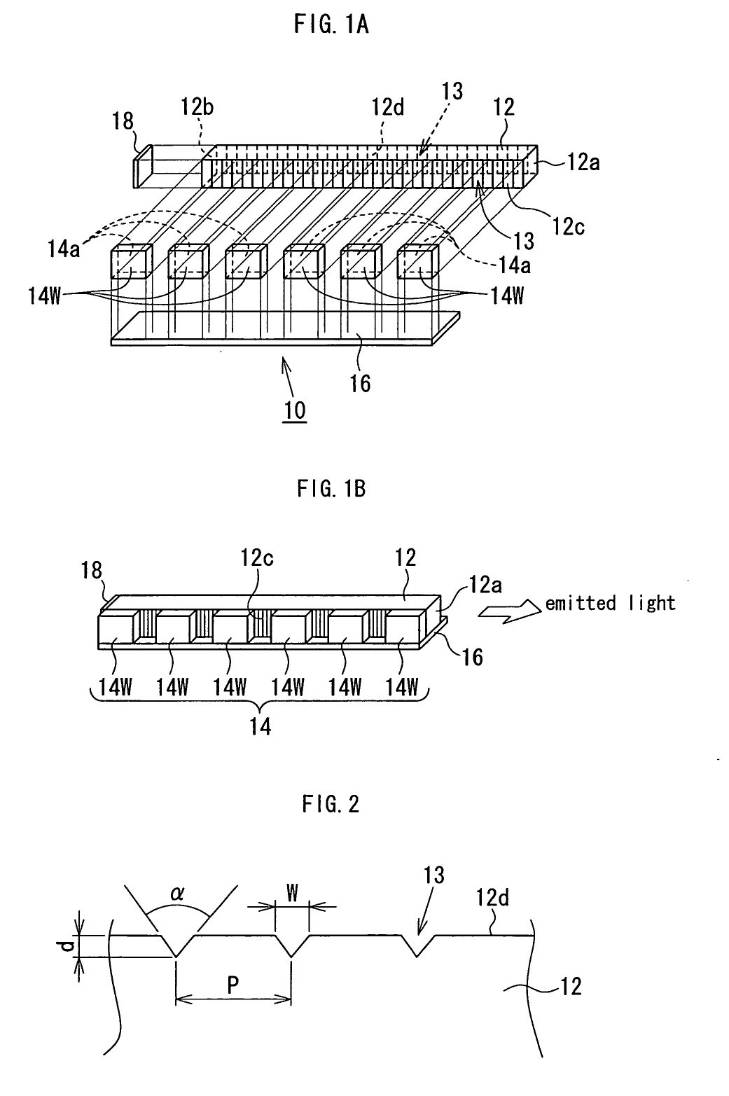

Referring to FIGS. 1A and 1B, an illuminating device 10 according to a first embodiment of the present invention includes a light source assembly 14 composed of a plurality of point light sources 14W, and a light guide bar 12. The light guide bar 12 according to the present embodiment is a quadrangular prism formed of a transparent material, such as glass, acrylic resin or polycarbonate resin, has an optical path converting means 13 (to be described later) provided on each of side surfaces 12c and 12d thereof positioned opposite to each other, and has a light reflection means 18 disposed on one end surface 12b (hereinafter referred to as light reflection surface as appropriate) thereof. The point light sources 14W are each constituted by a white light emitting diode (hereinafter referred to as white LED as appropriate), mounted on a circuit board 16 on which a wiring pattern (not shown) to feed electric power to the point light sources 14W is formed, and are arrayed in a line parallel to the longitudinal direction of the light guide bar 12 with light emitting surfaces 14a facing the side surface 12c of the light guide bar 12. In the illuminating device 10 described above, lights emitted from the point light sources 14W are introduced into the light guide bar 12 from the side surface 12c, adapted to propagate through the light guide bar 12 in the longitudinal direction, and exit out from another end surface 12a (hereinafter referred to as light exit surface).

In the present invention, the light reflection means 18 is not limited to any specific structure and may be constituted by a reflection film sticking or adhering to the end surface 12b, or by metal, for example silver or aluminum, evaporation-deposited on the end surface 12b. Also, the circuit board 16 may be constituted by, for example, a flexible printed board, and preferably include an appropriate heat radiating means to release heat generated by the point light sources 14W

The aforementioned optical path converting means 13 provided on each of the side surfaces 12c and 12d of the light guide bar 12 includes a plurality of grooves extending in the thickness direction (vertically in FIG. 1A) of the light guide bar 12. Referring to FIG. 2, the grooves have a triangular configuration in cross section, preferably with a width W of 0.1 mm, a depth d of 0.07 mm, and a vertex angle a of 72 degrees, and are arrayed at an interval P of 0.5 mm.

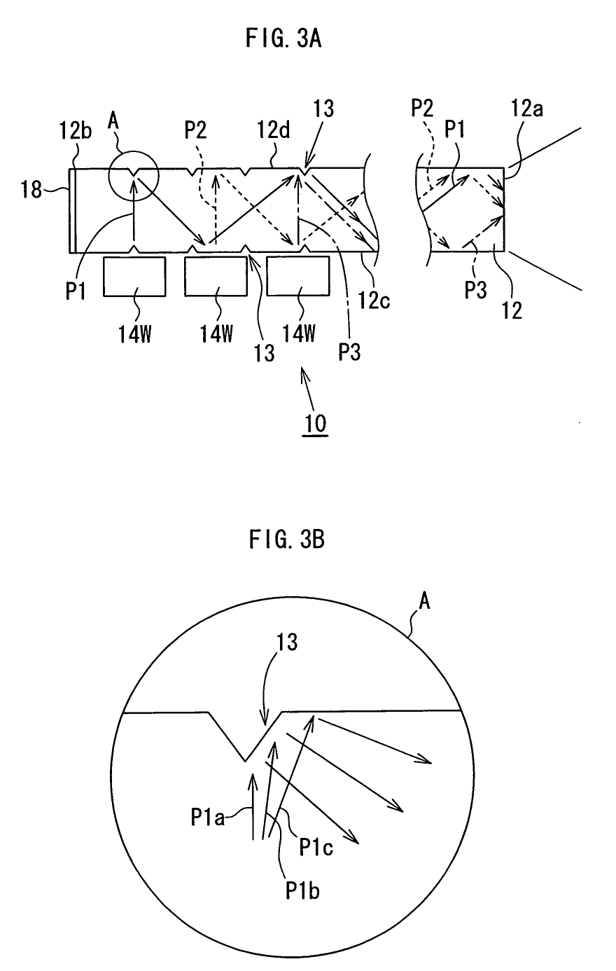

The operation and advantage of the illuminating device 10 will be described with reference to FIGS. 3A and 3B. Referring to FIG. 3A, lights emitted from the point light sources 14W are introduced into the light guide bar 12 from the side surface 12c, propagate toward the light exit surface 12a along optical paths P1, P2, P3 and so, are repeatedly reflected at the optical path converting means 13 during the propagation. With the repeated reflection, respective lights introduced into the light guide bar 12 are mixed randomly, whereby influences from the array geometry of the point light sources 14A and from the emission distribution bias of light from the point light sources 14A fade away, and uniformly multiplexed light rays ext out from the light exit surface 12a.

Referring to FIG. 3B, optical paths P1a, P1b and P1c which come divergingly from the optical path P1 are adapted to diffuse after reflection at the groove (prism) of the optical path converting means 13, and such reflection is repeated at each groove so as to accumulate light diffusion, whereby lights are significantly better mixed compared with reflection at, for example, a metallic mirror surface, or with total internal reflection at a uniform plane surface. In addition, light mixture can be optimized by modifying the groove parameters, namely, the aforementioned width W, the depth d, the vertex angle α, the interval P, and also the groove configuration, so as to change reflection characteristics. Further, though not illustrated, some of lights reflected at the optical path converting means 13 are adapted to proceed toward the light reflection surface 12b and reflected at the light reflection means 18 so as to proceed toward the light exit surface 12a thus traveling a longer distance than lights to proceed immediately and directly toward the light exit surface 12a, which increases the number of reflections at the optical path converting means 13 resulting in enhancing uniformity of light.

In the light source assembly 14 according to the present embodiment, the point light sources 14A are arranged not two-dimensionally so as to constitute a surface light source but one-dimensionally in the longitudinal direction of the light guide bar 12 along the side surface 12c. With the structure described above, lights emitted from the point light sources 14W and introduced into the light guide bar 12 from the side surface 12c have their optical paths changed by the optical path converting means 13 formed at the side surfaces 12c and 12d, propagate in the longitudinal direction of the light guide bar 12, and are multiplexed along the common optical axis. Consequently, the cross section area of the light guide bar 12 does not have to be adjusted to the number of point light sources 14W, and a basic requirement is that the area of the side surface 12c be comparable with the aggregate area of the light emitting surfaces 14a of the plurality of point light sources 14W. If the number of point light sources 14W is increased, the length of the light guide bar 12 may be increased as necessary, with the cross section area of the light guide bar 12 kept unchanged. This allows lights from the point light sources 14W to be reflected for increased times at the optical path converting means 13 thus preventing deterioration in the function of multiplexing and uniforming lights.

In the present embodiment, the optical path converting means 13 is provided at each of the side surfaces 12c and 12d of the light guide bar 12 positioned opposite to each other, and this structure is preferable for achieving an enhanced spreading distribution of lights emitted from the point light sources 14W The present invention, however, is not limited to this structure and may be structured such that the optical path converting means 13 is formed only on one side surface (for example 12d) with the light source assembly 14 disposed at another side surface (for example 12c) which is positioned opposite to the one side surface (12c), and at which the optical path converting means 13 is not formed.

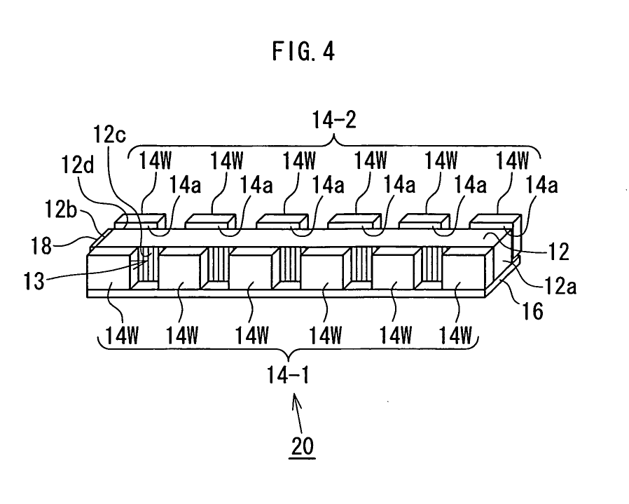

A second embodiment of the present invention will be described with reference to FIG. 4. In explaining the second embodiment (and also subsequent embodiments), any component parts corresponding to those in FIGS. 1A and 1B are denoted by the same reference numerals, and a detailed description thereof will be omitted below. Referring to FIG. 4, an illuminating device 20 according to the second embodiment of the present invention includes two light source assemblies 14-1 and 14-2 each composed of a plurality of point light sources 14W, and a light guide bar 12. The light guide bar 12 of the illuminating device 20 is structured identical with that of the illuminating device 10 according to the first embodiment described above. Specifically, the light guide gar 12 is constituted by a quadrangular prism formed of a transparent material, such as glass, acrylic resin or polycarbonate resin, has an optical path converting means 13 provided on each of side surfaces 12c and 12d (the optical path converting means 13 on the side surface 12d is not shown or indicated in the figure) thereof positioned opposite to each other, and has a light reflection means 18 disposed on one end surface 12b thereof. The illuminating device 20 of the present embodiment differs from the illuminating device 10 of the first embodiment in that two light source assemblies 14-1 and 14-2 are provided rather than one light source assembly 14 in the illuminating device 10, such that the light source assembly 14-1 composed of an array of white LEDs 14W is disposed on a circuit board 16 in the longitudinal direction along the side surface 12c of the light guide bar 12 with light emitting surfaces 14a (not shown in the figure) of the white LEDs 14W facing the side surface 12c, and that the light source assembly 14-2 composed of an array of white LEDs 14W is disposed on the circuit board 16 in the longitudinal direction along the side surface 12d of the light guide bar 12 with light emitting surfaces 14a of the white LEDs 14W facing the side surface 12d.

With the structure described above, the illuminating device 20 of the present embodiment achieves the same advantages obtained by the illuminating device 10, and in addition flexibly enables balance adjustment between the number of the point light sources 14W and the length of the light guide bar 12 when compared with the illuminating device 10. For example, an increased luminance can be achieved with a doubled number of the point light sources 14W disposed at the light guide bar 12 of the same length thus causing substantially no increase in the dimension of the illuminating device 20. Or, a necessary luminance can be maintained with the same number of the point light sources 14W disposed at the light guide bar 12 of a reduced length thus downsizing the illuminating device 20.

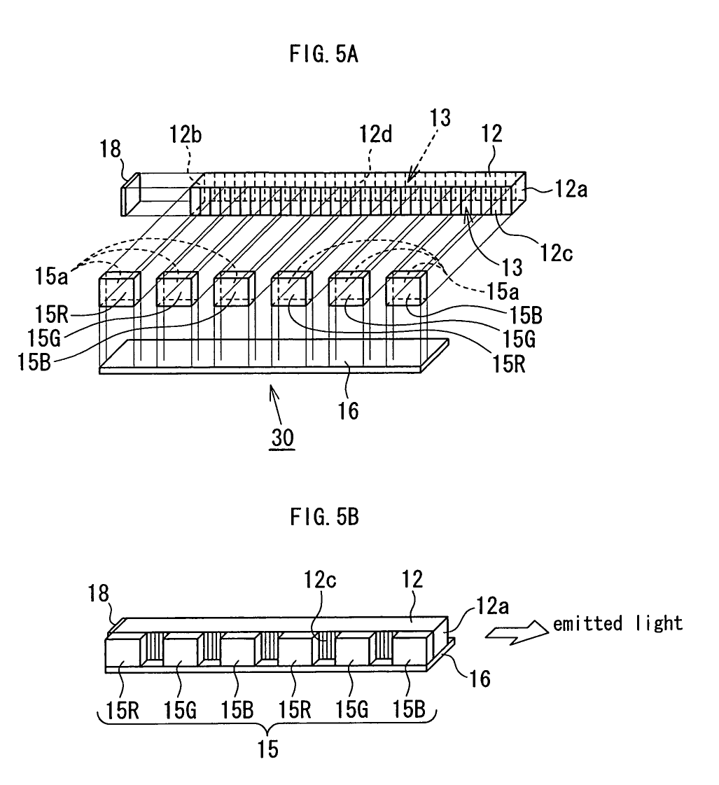

Referring to FIGS. 5A and 5B, an illuminating device 30 according to a third embodiment of the present invention includes a light source assembly 15 composed of a plurality of point light sources 15R, 15G and 15B for respective different colors, and a light guide bar 12. The light guide bar 12 of the illuminating device 30 is structured identical with that of the illuminating device 10 according to the first embodiment described above. Specifically, the light guide bar 12 is constituted by a quadrangular prism formed of a transparent material, such as glass, acrylic resin or polycarbonate resin, has an optical path converting means 13 provided on each of side surfaces 12c and 12d thereof positioned opposite to each other, and has a light reflection means 18 disposed on one end surface 12b thereof. The illuminating device 30 of the present embodiment differs from the illuminating device 10 of the first embodiment in that the light source assembly 15 include three different kinds of LEDs for respective different colors, namely 15R (red LED), 15G (green LED), and 15B (blue LED). The point light sources 15R, 15G and 15B are arrayed on a circuit board 16 along a side surface 12c of the light guide bar 12 with their light emitting surfaces 15a facing the side surface 12c.

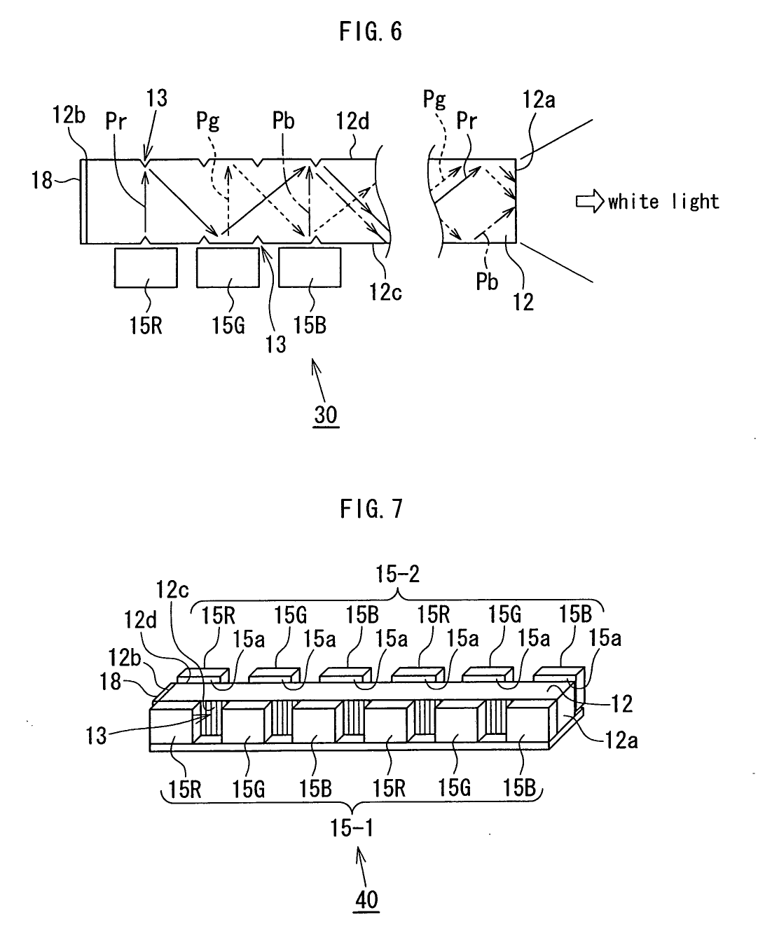

With the structure described above, the illuminating device 30 of the present embodiment has the same function of multiplexing and uniforming lights as the illuminating device 10. Specifically, referring to FIG. 6, lights emitted from the point light sources 15R, 15G and 15B are introduced into the light guide bar 12 from the side surface 12c, and propagate toward the light exit surface 12a along optical paths Pr, Pg and Pb while repeatedly reflected at the optical path converting means 13. During the propagation with repeated reflections, respective lights introduced into the light guide bar 12 are mixed randomly, whereby influences from the array geometry of the point light sources 115R, 15G and 5B and from the emission distribution bias of light from the point light sources 15R, 15G and 15B fade away, and uniformly multiplexed light rays ext out from the light exit surface 12a.

In the illuminating device 30 described above, the numbers, arrangements and driving currents of respective point light sources 15R, 15G and 15B can be appropriately set thereby adjusting balance of light amounts for respective luminescent colors so as to achieve white light having a desired spectrum distribution. And, the color combination of the point light sources constituting the light assembly 15 is not limited to red, green and blue, as long as a desired white light is achieved.

Referring to FIG. 7, an illuminating device 40 according to a fourth embodiment of the present invention includes two light source assemblies 15-1 and 15-2, and a light guide bar 12. The light guide bar 12 of the illuminating device 40 is structured identical with that of the illuminating device 30 according to the third embodiment described above. Specifically, the light guide bar 12 is constituted by a quadrangular prism formed of a transparent material, such as glass, acrylic resin or polycarbonate resin, has an optical path converting means 13 provided on each of side surfaces 12c and 12d (the optical path converting means 13 on the side surface 12d is not shown or indicated in the figure) thereof positioned opposite to each other, and has a light reflection means 18 disposed on one end surface 12b thereof. The illuminating device 40 of the present embodiment differs from the illuminating device 30 of the third embodiment in that two light source assemblies 15-1 and 15-2 are provided rather than one light source assembly 15 in the illuminating device 30, such that the light source assembly 15-1 including a plurality of point light sources 15R, 15G and 15B for respective different colors is disposed on a circuit board 16 in the longitudinal direction along the side surface 12c of the light guide bar 12 with light emitting surfaces 15a (not shown in the figure) of the point light sources 15R, 15G and 15B facing the side surface 12c, and that the light source assembly 15-2 including a plurality of point-light sources 15R, 15G and 15B for respective different colors is disposed on the circuit board 16 in the longitudinal direction along the side surface 12d of the light guide bar 12 with light emitting surfaces 15a of the point light sources 15R, 15G and 15B facing the side surface 12d.

With the structure described above, the illuminating device 40 of the present embodiment achieves the same advantages obtained by the illuminating device 30, and in addition flexibly enables balance adjustment between the number of the point light sources 15R/G/B and the length of the light guide bar 12 when compared with the illuminating device 30. For example, an increased luminance can be achieved with a doubled number of the point light sources 15R/G/B disposed at the light guide bar 12 of the same length thus causing substantially no increase in the dimension of the illuminating device 40. Or, a necessary luminance can be maintained with the same number of the point light sources 15R/G/B disposed at the light guide bar 12 of a reduced length thus downsizing the illuminating device 40.

Image display apparatuses according to the present invention will hereinafter be explained with reference to the accompanying drawings. While the following explanations will describe the image display apparatuses as including the illuminating device 10 according to the first embodiment, it should be appreciated that the present invention is not limited thereto and the image display apparatuses may alternatively include any one of the illuminating devices 20, 30 and 40 described above.

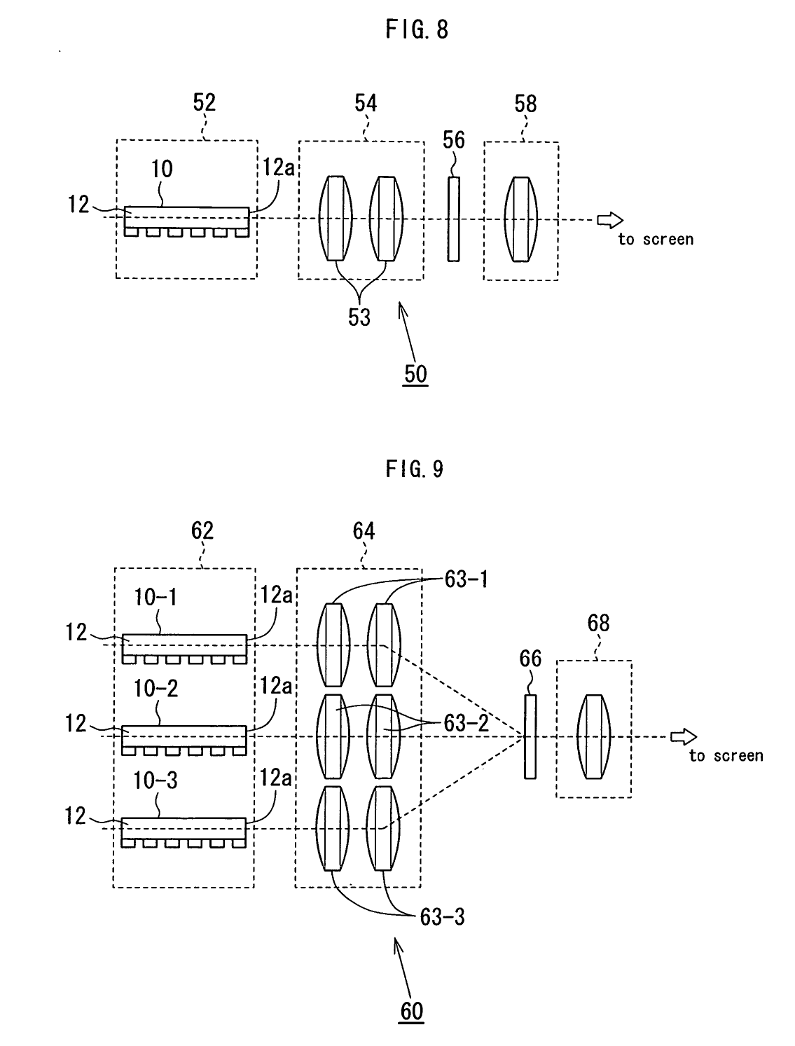

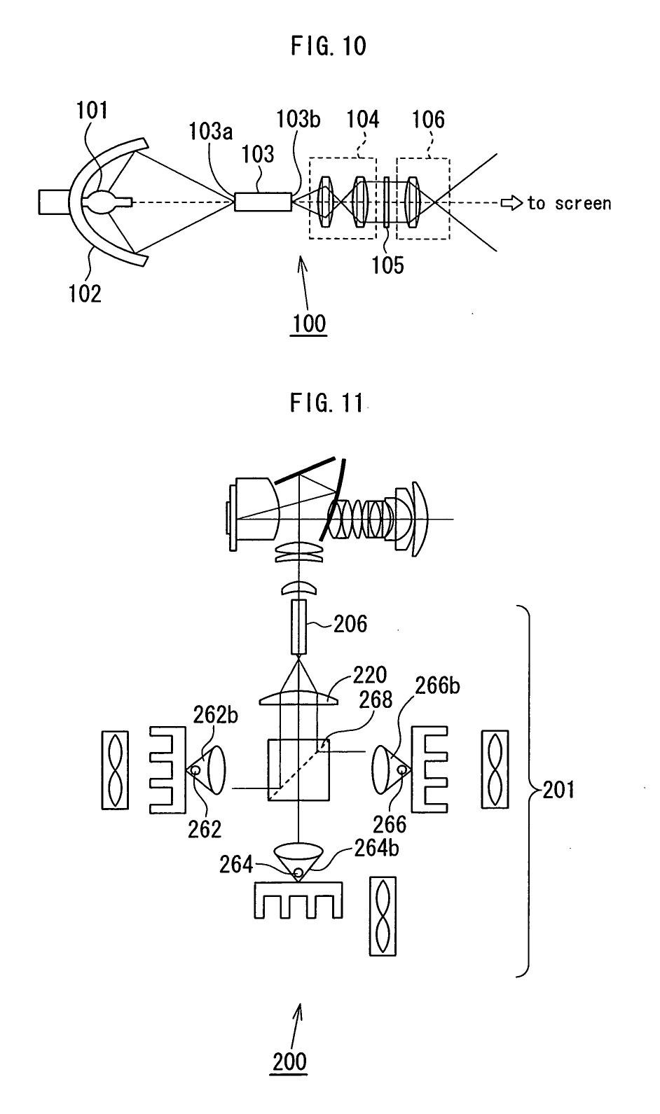

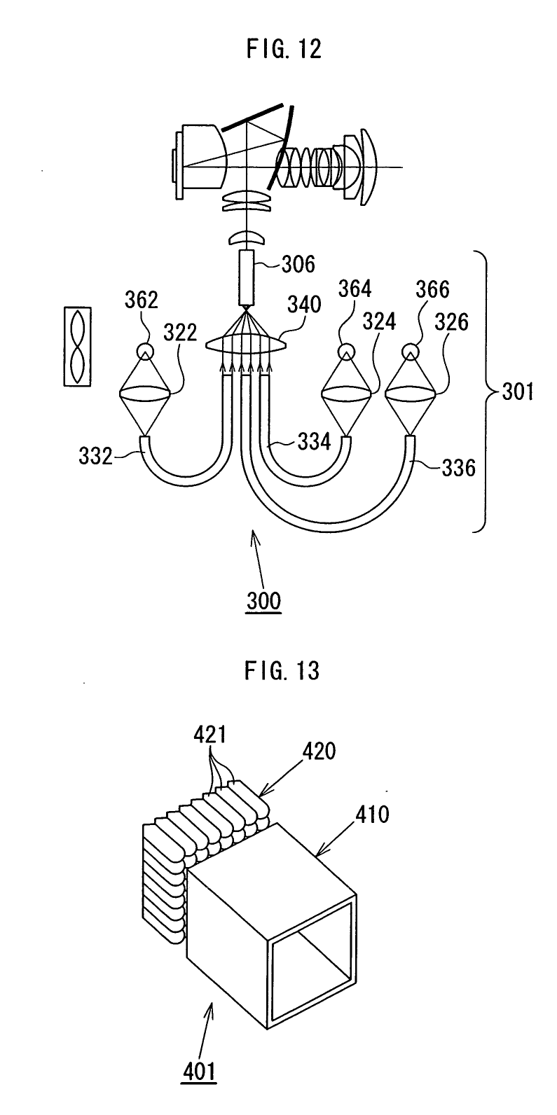

Referring to FIG. 8, an image display apparatus 50 according to a fifth embodiment of the present invention includes a illumination optical system 52 incorporating the illuminating device 10 described above, a light modulating means 56 to spatially modulate light from the illumination optical system 52 based on image information, a projection optical system 58 to magnify and project light from the light modulating means 56, and a condensing optical system 56 constituted by condenser lenses 53, disposed between the illumination unit 52 and the light modulating means 56, and adapted to appropriately magnify or reduce light rays from a light exit surface 12a of the illuminating device 10 so as to irradiate the light rays onto the light modulating means 56. In the present embodiment, the light modulating means 56 is constituted by a light transmissible liquid crystal display element to control transmission/non-transmission of light on a pixel-by-pixel basis according to the image information from a driving apparatus (not shown), and includes a color filter each color pixel of which is composed of red, green and blue pixels.

The image display apparatus 50 described above is a projection type image display apparatus, in which light from the illumination optical system 52 is guided to the light modulating means 56 via the condensing optical system 54, modulated by the light modulating means 56 based on image information, and projected by the projection optical system 58 onto a screen, and the like thereby displaying image. Since the illuminating device 10 incorporated in the illumination optical system 52 includes the light guide bar 12 whose dimension and weight are reduced due to the integrally structured means of multiplexing and uniforming lights from a plurality of point light sources, a drastic reduction is achieved in the dimension and weight of the illumination optical system 52, consequently the image display apparatus 50. Also, since the illuminating device 10 includes point light sources constituted by LEDs which can be battery-driven on a simple driving circuit, the image display apparatus 50 incorporating the illuminating device 10 is suitable for use as a portable projector powered by battery.

In the image display apparatus 50 described above, the light modulating means 56 is constituted by a light transmissible liquid crystal display (LCD) element provided with a color filter, and this is preferable for achieving a simple structure and a low cost for the image display apparatus 50. The present invention, however, is not limited to this structure, and the illuminating device 10 may alternatively be incorporated in an image display apparatus employing any optional color separating means and/or a reflection type light modulating means such as a light reflective liquid crystal display (LCD) element, and a digital micro device (DMD) element.

Referring to FIG. 9, an image display apparatus 60 according to a sixth embodiment of the present invention includes an illumination optical system 62, a light modulating means 66, a projection optical system 68, and a condensing optical system 64, and is basically identical in structure and operation with the image display apparatus 50 of the fifth embodiment described above, with difference therefrom found in that the illumination optical system 62 is constituted by a plurality (three in the figure) of illuminating devices 10-1, 10-2 and 10-3 each of which is identical with the illuminating device 10, and in that the condensing optical system 64 is constituted by a plurality of condenser lenses (units) 63-1, 63-2 and 63-3 corresponding respectively to the illuminating devices 10-1, 102 and 103. In this connection, the condensing optical system 64 has a function to appropriately magnify or reduce light rays from respective light emitting surfaces 12a of the illuminating devices 10-1, 10-2 and 10-3 so as to provide a uniform irradiation on the light modulating means 66, and may alternatively be constituted by any optional optical system as long as such a function is ensured.

Thus, an image display apparatus according to the present invention has a comparatively simple structure and is adapted to readily incorporate a plurality of illuminating devices 10 as shown in FIG. 9, thereby enabling an image to be projected with a desired brightness.

1. An illuminating device comprising:
a light guide bar having a quadrangular prism configuration, formed of a transparent material, and having an optical path converting means provided on at least one of two side surfaces thereof opposite to each other; and
a light source assembly comprising a plurality of point light sources and disposed at at least one of the two side surfaces of the light guide bar, wherein the plurality of point light sources are arrayed in a line along a longitudinal direction of the light guide bar such that light emitting surfaces of the point light sources face one of the two side surfaces of the light guide bar, whereby lights from the point light sources are introduced into the light guide bar from the one side surface, propagate along the longitudinal direction of the light guide bar, and exit out from one end surface of the light guide bar.

2. An illuminating device according to claim 1, wherein the optical path converting means comprises a plurality of grooves formed on the side surface of the light guide bar.

3. An illuminating device according to claim 1, wherein the plurality of point light sources include a white light emitting diode.

4. An illuminating device according to claim 1, wherein the plurality of point light sources include a red light emitting diode, a green light emitting diode, and a blue light emitting diode.

5. An image display apparatus comprising:
an illuminating device as described in claim 1;
a light modulating means to spatially modulate light from the illuminating device based on image information; and
a projection optical system to magnify and project light from the light modulating means.

6. An image display apparatus according to claim 5, wherein the light modulating means is constituted by a liquid crystal display element.

7. An image display apparatus according to claim 5, wherein the light modulating means is constituted by a digital micro device element.
